(19) United States
(12) Patent Application Publication
(10) Pub. No.: US 2013/0321630 A1
(43) Pub. Date: Dec. 5, 2013

(54) SYSTEM AND METHOD FOR LANE DEPARTURE WARNING

(71) Applicant: HYUNDAI MOBIS CO., LTD., Yongin-si (KR)

(72) Inventor: Chang Mok SHIN, Yongin-si (KR)

(73) Assignee: HYUNDAI MOBIS CO., LTD., Yongin-si (KR)

(21) Appl. No.: 13/847,509

(22) Filed: Mar. 20, 2013

(30) Foreign Application Priority Data
Jun. 5, 2012 (KR) 10-2012-0060510

(51) Int. Cl. G08G 1/16

(52) U.S. Cl. CPC G08G 1/167
USPC 348/148

(57) ABSTRACT

A lane departure warning system and method are provided. The lane departure warning system includes a camera, a tunnel recognition module, a virtual lane module, and a determination/warning module. The camera captures a front image of a vehicle. The tunnel recognition module determines whether a current position of the vehicle is in a tunnel section, using the front image captured by the camera. The virtual lane module determines whether two or more lanes are detected from the front image when the current position is in the tunnel section and, when only one lane is detected, generates a virtual lane at a position corresponding to the one lane using a pre-calculated road width. The determination/warning module determines whether the vehicle departs from a lane, using the one lane and the virtual lane or the two or more lanes detected, and warns of lane departures accordingly.

### CROSS-REFERENCE TO RELATED APPLICATIONS

This application claims priority under 35 U.S.C. §119 to Korean Patent Application No. 10-2012-0060510, filed on Jun. 5, 2012, the disclosure of which is incorporated herein by reference in its entirety.

### TECHNICAL FIELD

The present disclosure relates to a lane departure warning system, and in particular, to a lane departure warning system and method that generates a virtual lane when inaccurately detecting a lane and determines whether a vehicle departs from a lane.

### BACKGROUND

Recently, as in advanced safety vehicles (ASVs), advanced vehicles to which advanced electronic technology and control technology have been applied are increasing.

A lane departure warning system captures the front image of a vehicle by camera mounted on the vehicle to detect a lane on which the vehicle is currently driving, and outputs warning sound to a driver when the vehicle departs from the lane.

When a vehicle is driving on a road on which a lane is not accurately detected due to a guardrail shadow or back light, a related art lane departure warning system generates a virtual lane on the basis of road width information to determine whether the vehicle departs from a lane.

However, a related art operation of generating a virtual lane increases system load, and has low reliability because the operation sometimes generate an inaccurate virtual lane. Accordingly, a related art lane departure warning system falsely warns of lane departure sometimes, and thus decreases the convenience of a driver and product reliability.

### SUMMARY

Accordingly, the present disclosure provides a lane departure warning system and method that generate a virtual lane when not detecting one of left and right lanes with respect to a vehicle in a tunnel, and use the virtual lane in determining whether the vehicle departs from a lane.

In one general aspect, a lane departure warning system includes: a camera capturing a front image of a vehicle; a tunnel recognition module determining whether a current position of the vehicle is in a tunnel section, using the front image captured by the camera; a virtual lane module determining whether two or more lanes are detected from the front image when the current position is in the tunnel section and, when only one lane is detected, generating a virtual lane at a position corresponding to the one lane using a pre-calculated road width; and a determination/warning module determining whether the vehicle departs from a lane using the one lane and the virtual lane or the two or more lanes detected and, when it is determined that the vehicle departs from the lane, warning of lane departure.

In another general aspect, a lane departure warning method by a lane departure warning system includes: determining whether a current position of a vehicle is in a tunnel section, using a front image captured by a camera; determining whether two or more lanes are detected from the front image, when the current position is in the tunnel section; generating, when only one lanes is detected, a virtual lane at a position corresponding to the one lane using a pre-calculated road width in the front image; determining whether the vehicle departs from a lane using the two or more lanes or the one lane and the virtual lane; and warning of lane departure when it is determined that the vehicle departs from the lane.

In another general aspect, a tunnel recognition module includes: a storage unit storing a tunnel brightness pattern that is set using a change of brightness value of an image captured in a tunnel section; and a control unit checking a change of brightness value of pixels disposed on a horizontal line and a vertical line that pass through a vanishing point for left and right lanes with respect to a vehicle, in a front image of the vehicle, and, when the change of brightness value corresponds to the tunnel brightness pattern, determining there to be possibility that a current position of the vehicle is in the tunnel section.

Other features and aspects will be apparent from the following detailed description, the drawings, and the claims.

### BRIEF DESCRIPTION OF THE DRAWINGS

FIG. 1 is a block diagram illustrating a lane departure warning system according to an embodiment of the present invention.

FIG. 2 is a block diagram illustrating a tunnel recognition module according to an embodiment of the present invention.

FIG. 3 is a flowchart illustrating a tunnel recognition method using a front image according to an embodiment of the present invention.

FIG. 4 is a diagram for describing a tunnel pattern determination method according to an embodiment of the present invention.

FIG. 5 is a flowchart illustrating a lane departure warning method according to an embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments will be described in detail with reference to the accompanying drawings.

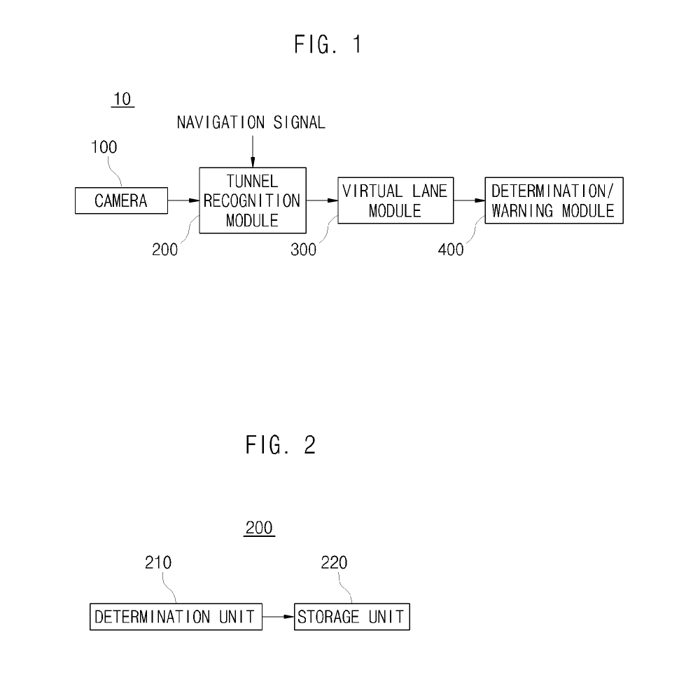

FIG. 1 is a block diagram illustrating a lane departure warning system according to an embodiment of the present invention.

Referring to FIG. 1, a lane departure warning system 10 according to an embodiment of the present invention includes a camera 100, a tunnel recognition module 200, a virtual lane module 300, and a determination/warning module 400.

Here, the lane departure warning system 10 may not separately include the camera 100, in which case the lane departure warning system 10 may receive a front image from another camera included in a vehicle and use the front image. Also, as disclosed in the specification, the tunnel recognition module 200, the virtual lane module 300, and the determination/warning module 400 may be separate elements, but may be implemented as one controller.

The camera 100 captures a front image (including the image of a front road of the vehicle) of a vehicle, and transfers the captured image to the tunnel recognition module 200.

For example, the camera 100 may be disposed in the rear of a rearview mirror of a vehicle, and capture a front image of the vehicle toward a windscreen of the vehicle.

The tunnel recognition module 200 recognizes a tunnel section using at least one of a front image and a signal from a navigation system. Here, when the tunnel recognition module 200 recognizes the tunnel section using both the front image and the signal from the navigation, reliability for tunnel recognition can be enhanced.

Here, the tunnel section may be a road that has a tunnel in the front within a certain distance from a current position of a vehicle, and may be an internal section of the tunnel.

The tunnel recognition module 200 is connected to the navigation system through a controller area network (CAN) or a data signal line. The tunnel recognition module 200 receives GPS coordinates from the navigation system, and compares the GPS coordinates with pre-stored tunnel position information to determine the current position of the vehicle as being in the tunnel section. Alternatively, the tunnel recognition module 200 may receive information, indicating the current position of the vehicle as being in the tunnel section, from the navigation system, and determine the current position of the vehicle as being in the tunnel section.

The tunnel recognition module 200 may determine the current position as being in the tunnel section using a front image. This will be described below.

The tunnel recognition module 200 checks the vanishing-point coordinates of left and right lanes from the front image, sets a region of interest (ROI) within a certain range on the basis of the vanishing-point coordinates in the front image, determines the current position of the vehicle as being in the tunnel section using the brightness values of pixels in the ROI, and transfers the recognized result to the virtual lane module 300. A detailed operation in which the tunnel recognition module 200 recognizes the tunnel section using the front image will be described below with reference to FIG. 2.

When the current position of the vehicle is determined as being in the tunnel section, the virtual lane module 300 checks whether left and right lanes with respect to the vehicle are normally detected in the tunnel section. When one of the left and right lanes is not normally detected, the virtual lane module 300 executes a virtual lane generation algorithm to generate a virtual lane on the basis of the detected lane.

When two lanes are detected in the tunnel section, the virtual lane module 300 calculates a mounting angle between a road surface and the camera 100 using vanishing-point coordinates that correspond to an intersection portion of the left and right lanes in each frame, calculates a distance for each pixel on the basis of the mounting angle, and calculates a road width in each frame by multiplying the distance for each pixel by an X-intercept difference value between the left and right lanes.

Moreover, the virtual lane module 300 stores an X-intercept, a Y-intercept, a road width, and vanishing-point coordinates in each frame, and calculates and stores an average X-intercept, an average Y-intercept, an average road width, and vanishing-point coordinates in the plurality of frames. Here, the average road width is used to generate a virtual lane.

When only one of the left and right lanes is detected in the tunnel section, the virtual lane module 300 generates a virtual lane on the other side (position of an undetected lane) that is separated by the calculated average road width from the detected lane, and performs an arithmetic operation on an X-intercept, a Y-intercept, and vanishing-point coordinates.

On the other hand, the virtual lane module 300 does not generate a virtual lane in places other than the tunnel section.

The determination/warning module 400 determines whether the vehicle departs from a lane, using the X-intercept, the Y-intercept, and the vanishing-point coordinates. When it is determined that the vehicle departs from the lane, the determination/warning module 400 outputs warning sound.

For example, when the Y-intercept is greater than a predetermined specific value, the determination/warning module 400 may determine the vehicle as departing from the lane, and output warning sound.

Various references disclose a virtual lane generation method and a lane departure detection method, and thus, the virtual lane generation method of the virtual lane module 300 and the lane departure detection method of the determination/warning module 400 are not limited to the specification. The virtual lane module 300 may generate a virtual lane in various schemes, and the determination/warning module 400 may detect lane departure in various schemes.

The lane departure warning system 10 is installed as one module, in the rear of a rearview mirror of the vehicle, capture a front image of the vehicle by an internal camera 100, and warn of lane departure through an internal speaker when the vehicle is determined as departing from the lane.

Hereinafter, a tunnel recognition method using a front image according to an embodiment of the present invention will be described with reference to FIGS. 2 to 4.

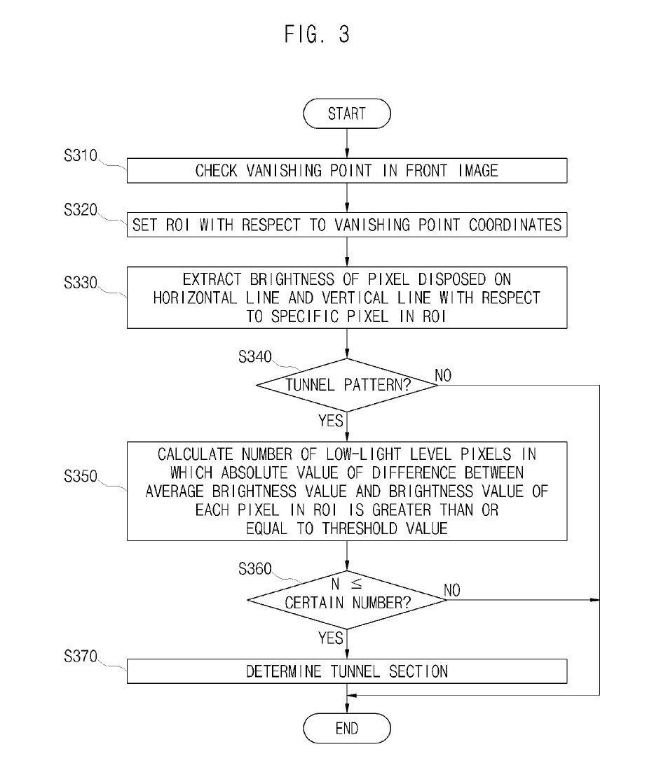

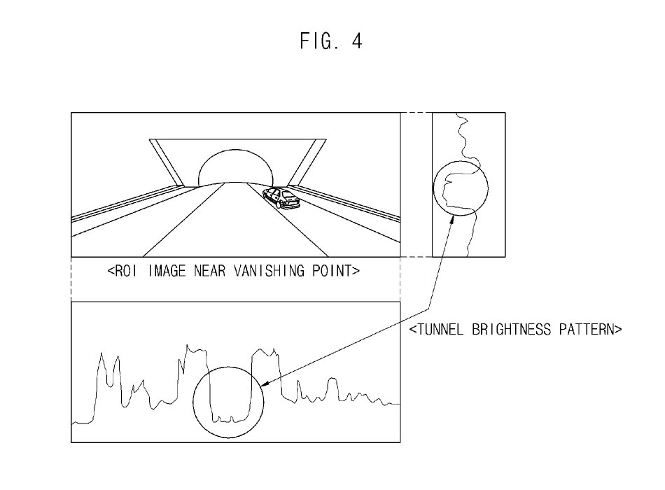

FIG. 2 is a block diagram illustrating a tunnel recognition module according to an embodiment of the present invention. FIG. 3 is a flowchart illustrating a tunnel recognition method using a front image according to an embodiment of the present invention. FIG. 4 is a diagram for describing a tunnel pattern determination method according to an embodiment of the present invention.

Referring to FIG. 2, the tunnel recognition module 200 includes a determination unit 210 and a storage unit 220.

The storage unit 220 stores reference information, such as a threshold value, a reference value, and a tunnel brightness pattern, for determining a tunnel section.

Here, the tunnel brightness pattern may be set averaging the change of brightness values of respective front images that are captured in a plurality of tunnel sections.

Moreover, the threshold value and the reference value may be set using the brightness values of respective front images that are captured in the plurality of tunnel sections.

Hereinafter, the tunnel recognition method of the determination method 210 will be described with reference to FIG. 3.

Referring to FIG. 3, the determination unit 210 checks vanishing-point coordinates corresponding to an intersection portion of left and right lanes with respect to a vehicle, on the basis of a front image of the vehicle in S310. Specifically, when two or more lanes are detected from the front image, the determination unit 210 checks left and right lanes with the two or more lanes, and checks the vanishing-point coordinates corresponding to the intersection portion of the left and right lanes.

Subsequently, the determination unit 210 sets an ROI on the basis of the vanishing-point coordinates in S320. Here, the ROI may be a region that has a certain range and includes a vanishing point.

In S330, the determination unit 210 extracts brightness values (pixel intensity) of pixels disposed on a horizontal line and a vertical line that pass through a specific pixel (for example, a vanishing point) in the ROI.

In this case, the tunnel recognition module 200 may convert the original front image including color information into a grayscale image, and extract the brightness values of the pixels disposed on the horizontal line and vertical line that pass through the vanishing point.

The determination unit 210 determines whether the change of brightness value of each of the pixels, which are disposed on the horizontal line and vertical line that pass through the vanishing point, corresponds to the tunnel brightness pattern stored in the storage unit 220 in S340. In this case, when the change of brightness value of each pixel corresponds to the tunnel brightness pattern, the determination unit 210 may determine there to be possibility that the current position of the vehicle is in a tunnel section.

Specifically, as shown in FIG. 4, the determination unit 210 checks the change of brightness value of each pixel, which is disposed on the horizontal line and vertical line that pass through the vanishing point, in a graph type. In this case, when a tunnel is disposed on the horizontal line and the vertical line, the brightness value of a corresponding pixel is considerably reduced, and thus, the determination unit 210 checks whether a graph, indicating change of brightness values, is a graph in which the brightness values of at least certain number of pixels are lowered to less than a certain value in positions near the vanishing point as in the tunnel brightness pattern.

When the change of brightness value of each pixel corresponds to the tunnel brightness pattern, the determination unit 210 checks the brightness values and average brightness value of the pixels in the ROI, and calculates the number “N” of low-light level pixels in which the absolute value of a difference between the average brightness value and the brightness value of each pixel in the ROI is greater than or equal to a predetermined threshold value, in S350.

The determination unit 210 determines whether the number “N” of low-light level pixels is less than or equal to a certain number, in S360. Here, the certain number may be determined using a plurality of front images that have been captured in a tunnel section.

When the number “N” of low-light level pixels is less than or equal to the certain number, the determination unit 210 determines a current position as being in a tunnel section, in S370. However, when the number “N” of low-light level pixels is greater than the certain number, the determination unit 210 determines the current position as not being in the tunnel section.

The determination unit 210 transfers the result of determining whether the current position is in the tunnel section, to the virtual lane module 300.

After the determination unit 210 determines the current position as being in the tunnel section, the determination unit 210 performs an arithmetic operation on the number “N” of low-light level pixels in units of a certain time. And when the number “N” of low-light level pixels exceeds the certain number, the determination unit 210 determines the vehicle as departing from the tunnel section and informs the departed result of the virtual lane module 300. Here, when the virtual lane module 300 receives the information, indicating that the vehicle departs from the tunnel section, from the tunnel recognition module 200, the virtual lane module 300 does not generate a virtual lane until the vehicle again enters into the tunnel section.

Instead of operations 5340 to 5360 or one of operations 5340 to 5360, the determination unit 210 may determine the current position of the vehicle as being in the tunnel section when the average brightness value of the pixels in the ROI is less than or equal to a predetermined reference value.

In the above-described embodiment, it has been described as an example that the determination unit 210 performs all of operations 5340 to 5360 to determine whether the current position of the vehicle is in the tunnel section. However, the determination unit 210 may perform only one of operations 5340 to 5360 to determine whether the current position of the vehicle is in the tunnel section.

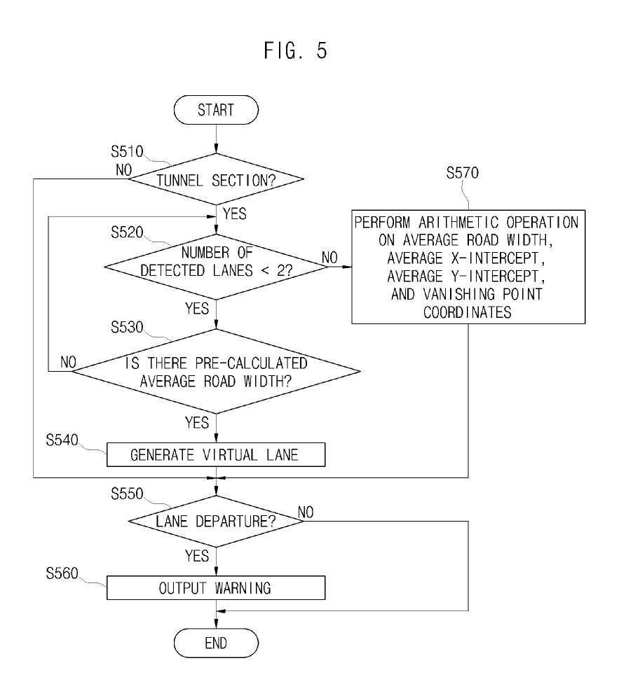

Hereinafter, a lane departure warning method according to an embodiment of the present invention will be described with reference to FIG. 5. FIG. 5 is a flowchart illustrating the lane departure warning method according to an embodiment of the present invention.

Referring to FIG. 5, the lane departure warning system 10 determines whether the current position of a vehicle is in a tunnel section, using a front image and a signal from a navigation system, in S510.

Specifically, the lane departure warning system 10 may determine the current position as being in the tunnel section by checking whether a change of the brightness value, which extracts the brightness value of each pixel in an ROI in the front image, corresponds to a tunnel brightness pattern. Or, the lane departure warning system 10 may determine the current position as being in the tunnel section extracting the brightness value of each pixel in an ROI being based on the vanishing point of left and right lanes with respect to the vehicle, from the front image and checking the brightness value of each pixel is less than or equal to a predetermined reference value. This has been described in detail with reference to FIGS. 2 to 4.

Alternatively, the lane departure warning system 10 may receive GPS coordinates from the navigation system, and compare the GPS coordinates with a predetermined tunnel position information to determine a tunnel section. Alternatively, the lane departure warning system 10 may receive information indicating a tunnel section from the navigation system to determine the tunnel section.

When the current position is in the tunnel section, the lane departure warning system 10 determines whether the number of lanes detected from the front image is less than two, in S520.

When the number of lanes detected in the tunnel section is less than two, the lane departure warning system 10 determines whether there is a pre-calculated average road width, in S530.

When there is the pre-calculated average road width, the lane departure warning system 10 generates a virtual lane with the one detected lane and the pre-calculated average road width, in S540.

The lane departure warning system 10 determines whether the vehicle departs from a lane, using the virtual lane and the detected lane in S550. When two or more lanes are detected, the lane departure warning system 10 determines whether the vehicle departs from the lane, using the two or more detected lanes.

When the vehicle departs from the lane, the lane departure warning system 10 warns of the risk of a driver, in S560.

When the number of detected lanes is two or more (i.e., when a lane is normally detected), the lane departure warning system 10 performs an arithmetic operation on an average road width, an average X-intercept, an average Y-intercept, and vanishing-point coordinates, and stores the arithmetically operated result in S570.

The lane departure warning system 10 determines the current position as being in the tunnel section, and then determines whether the vehicle departs from the tunnel section, using the front image or the signal from the navigation system. When the vehicle departs from the tunnel section, the lane departure warning system 10 does not generate a virtual lane until the vehicle again enters into the tunnel section.

According to the above-described embodiments, the present invention generates a virtual lane when not detecting one of left and right lanes with respect to a vehicle in a tunnel, and thus can supplement the detection of a damaged lane section in the tunnel and decrease system load.

Moreover, the present invention does not separately generate a virtual lane in places other than a tunnel, and thus can overcome drawbacks such as that the related art lane departure warning system inaccurately detects a lane when using a virtual lane. Accordingly, the present invention can enhance reliability and accuracy for lane detection, and enhance performance which a user feels.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A lane departure warning system, comprising:
a camera capturing a front image of a vehicle;
a tunnel recognition module determining whether a current position of the vehicle is in a tunnel section, using the front image captured by the camera;
a virtual lane module determining whether two or more lanes are detected from the front image when the current position is in the tunnel section and, when only one lane is detected, generating a virtual lane at a position corresponding to the one lane using a pre-calculated road width; and
a determination/warning module determining whether the vehicle departs from a lane using the one lane detected and the virtual lane or the two or more lanes detected and, when it is determined that the vehicle departs from the lane, warning of lane departure.

2. The lane departure warning system of claim 1, wherein,
the tunnel recognition module receives GPS coordinates of the current position from a navigation system, and compares the GPS coordinates with a pre-stored tunnel position coordinates to determine whether the current position is in the tunnel section, or
the tunnel recognition module receives information, which indicates the current position being in the tunnel section, from the navigation system to determine the current position as being in the tunnel section.

3. The lane departure warning system of claim 1, wherein,
the tunnel recognition module checks a vanishing point at which the two or more lanes intersect, and checks a change of brightness value of pixels disposed on a horizontal line and a vertical line that pass through the vanishing point, in the front image, and
when the change of brightness value corresponds to a predetermined tunnel brightness pattern, the tunnel recognition module determines the current position as being in the tunnel section.

4. The lane departure warning system of claim 1, wherein,
the tunnel recognition module checks a vanishing point at which left and right lanes with respect to the vehicle among the two or more lanes intersect, in the front image, sets an ROI having a certain range with respect to the vanishing point to check brightness values of pixels in the ROI, calculates an average brightness value of the pixels in the ROI, and calculates the number of pixels in the ROI in which an absolute value of a difference between the average brightness value and the brightness value of each of the pixels is greater than or equal to a predetermined threshold value, and
when the calculated number of pixels is less than or equal to a predetermined number, the tunnel recognition module determines the current position as being in the tunnel section.

5. The lane departure warning system of claim 1, wherein,
the tunnel recognition module checks a vanishing point at which left and right lanes with respect to the vehicle among the two or more lanes intersect, and
when an average brightness value of a plurality of pixels in an ROI having a certain range with respect to the vanishing point is less than or equal to a predetermined reference value, the tunnel recognition module determines the current position as being in the tunnel section.

6. The lane departure warning system of claim 1, wherein when the two or more lanes are detected in the tunnel section or, the current position is not in the tunnel section,
the virtual lane module does not generate the virtual lane, and checks left and right lanes with respect to the vehicle among the two or more lanes to calculate and saves the road width between the left and right lanes.

7. The lane departure warning system of claim 1, wherein when the tunnel section is determined, the tunnel recognition module determines whether the vehicle departs from the tunnel section, on the basis of the at least one information.

8. A lane departure warning method by a lane departure warning system, comprising:
determining whether a current position of a vehicle is in a tunnel section, using a front image captured by a camera;
determining whether two or more lanes are detected from the front image, when the current position is in the tunnel section;
generating, when only one lanes is detected, a virtual lane at a position corresponding to the one lane using a pre-calculated road width in the front image;
determining whether the vehicle departs from a lane using the two or more lanes or the one lane and the virtual lane; and
warning of lane departure when it is determined that the vehicle departs from the lane.

9. The lane departure warning method of claim 8, wherein the determining of whether a current position of a vehicle is in a tunnel section comprises:
receiving GPS coordinates of the current position from a navigation system, and comparing the GPS coordinates with a pre-stored tunnel position coordinates to determine whether the current position is in the tunnel section; or
receiving information, which indicates the current position being in the tunnel section, from the navigation system to determine the current position of the vehicle as being in the tunnel section.

10. The lane departure warning method of claim 8, wherein the determining of whether a current position of a vehicle is in a tunnel section comprises:
checking a vanishing point at which the two or more lanes intersect, in the front image;
checking a change of brightness value of pixels disposed on a horizontal line and a vertical line that pass through the vanishing point, in the front image; and
determining the current position as being in the tunnel section when the change of brightness value corresponds to a predetermined tunnel brightness pattern.

11. The lane departure warning method of claim 8, wherein the determining of whether a current position of a vehicle is in a tunnel section comprises:
setting an ROI with respect to a vanishing point at which left and right lanes with respect to the vehicle among the two or more lanes intersect, in the front image;
checking brightness values of pixels in the ROI to calculate an average of the brightness values; and
determining the current position as being in the tunnel section when the average of brightness value is less than or equal to a predetermined reference value.

12. A tunnel recognition module, comprising:
a storage unit storing a tunnel brightness pattern that is set using a change of brightness value of an image captured in a tunnel section; and
a control unit checking a change of brightness value of pixels disposed on a horizontal line and a vertical line that pass through a vanishing point for left and right lanes with respect to a vehicle, in a front image of the vehicle, and, when the change of brightness value corresponds to the tunnel brightness pattern, determining there to be possibility that a current position of the vehicle is in the tunnel section.

13. The tunnel recognition module of claim 12, wherein,
the storage unit further stores a threshold value,
the control unit sets an ROI having a certain range with respect to the vanishing point, calculates brightness values of pixels in the ROI and an average brightness value of the pixels in the ROI, and calculates the number of pixels in the ROI in which an absolute value of a difference between the average brightness value and the brightness value of each of the pixels in the ROI is greater than or equal to a predetermined threshold value, and
when the calculated number of pixels is less than or equal to a predetermined number, the control unit determines the current position as being in the tunnel section.

14. The tunnel recognition module of claim 12, wherein,
the control unit sets an ROI having a certain range with respect to the vanishing point, and
when an average brightness value of the pixels in the ROI is less than or equal to a predetermined reference value, the control unit determines the current position as being in the tunnel section.
